(19) United States
(12) Patent Application Publication
(10) Pub. No.: US 2025/0086828 A1
(43) Pub. Date: Mar. 13, 2025

(54) HUMAN POSE ESTIMATION FROM POINT CLOUD DATA

(71) Applicant: TuSimple, Inc., SAN DIEGO, CA (US)

(72) Inventors: Dongqiangzi YE, San Diego, CA (US); Yufei XIE, San Jose, CA (US); Weijia CHEN, San Diego, CA (US); Zixiang ZHOU, Orlando, FL (US); Lingting GE, San Diego, CA (US)

(21) Appl. No.: 18/818,790

(22) Filed: Aug. 29, 2024

Related U.S. Application Data
(60) Provisional application No. 63/581,227, filed on Sep. 7, 2023.

(51) Int. Cl. G06T 7/73; G01S 17/89; G06T 7/12; G06T 17/00; G06V 10/25; G06V 10/80

(52) U.S. Cl. CPC G06T 7/73; G01S 17/89; G06T 7/12; G06T 17/00; G06V 10/25; G06V 10/806; G06T 2207/30196; G06V 2201/07

(57) ABSTRACT

An image processing method includes performing, using images obtained from one or more sensors onboard a vehicle, a 2-dimensional (2D) feature extraction; performing, a 3-dimensional (3D) feature extraction on the images; detecting objects in the images by fusing detection results from the 2D feature extraction and the 3D feature extraction.

### CROSS-REFERENCE TO RELATED APPLICATIONS

This document claims priority to and the benefit of U.S. Provisional Application No. 63/581,227, filed on Sep. 7, 2023. The aforementioned application of which is incorporated herein by reference in its entirety.

### TECHNICAL FIELD

This document relates to tools (systems, apparatuses, methodologies, computer program products, etc.) for image processing, and more particularly, processing images received from a light detection and ranging, lidar, sensor onboard a self-driving vehicle.

### BACKGROUND

Awareness of a vehicle to surrounding objects can serve an important purpose of safe driving. This awareness may be especially useful if the vehicle is a self-driving vehicle that takes decision about path navigation.

### SUMMARY

Disclosed are devices, systems and methods for analyzing point cloud data to determine pose of human objects detected in the point cloud. The detected human objects may be used to make navigation decisions.

In one aspect, a disclosed method includes estimating, by performing a two-stage analysis, a pose of a human object in a point cloud received from a light detection and ranging (lidar) sensor, wherein the two-stage analysis includes: a first stage in which at least three feature sets are generated from the point cloud by performing a three-dimensional (3D) object detection and a 3D semantic segmentation on the point cloud, wherein the at least three feature sets include a first set that includes local point information; and a second stage that generates one or more human pose keypoints for the human object in the point cloud by analyzing the at least three feature sets using an attention mechanism.

In another aspect, a disclosed apparatus includes one or more processors configured to implement the above-recited method.

In another aspect, an autonomous vehicle comprising a lidar sensor to obtain a point cloud data and one or more processors configured to process the point cloud data using the above-recited method is disclosed.

In another exemplary aspect, the above-described method is embodied in a non-transitory computer readable storage medium. The non-transitory computer readable storage medium includes code that when executed by a processor, causes the processor to perform the methods described in this patent document.

In yet another exemplary embodiment, a device that is configured or operable to perform the above-described methods is disclosed.

The above and other aspects and features of the disclosed technology are described in greater detail in the drawings, the description and the claims.

### BRIEF DESCRIPTION OF THE DRAWINGS

FIG. 1 is an example of a vehicular computational platform.

FIG. 2 depicts an example of predicted three-dimensional (3D) keypoints in a point cloud.

FIG. 3 is a block diagram of an example implementation of a two-stage system for estimating human pose.

FIG. 4 is a block diagram of an example of a keypoint transformed.

FIGS. 5 to 7 show examples of prediction results.

FIG. 8 shows an example of prediction results for a whole scene.

FIG. 9 depicts a table of example results.

FIG. 10 depicts tables of example results.

FIG. 11 is a flowchart of an example method of point cloud data processing.

### DETAILED DESCRIPTION

Section headings are used in the present document for ease of cross-referencing and improving readability and do not limit scope of disclosed techniques. Furthermore, various image processing techniques have been described by using examples of self-driving vehicle platform as an illustrative example, and it would be understood by one of skill in the art that the disclosed techniques may be used in other operational scenarios also (e.g., surveillance, medical image analysis, image search cataloguing, etc.).

The transportation industry has been undergoing considerable changes in the way technology is used to control vehicles. A semi-autonomous and autonomous vehicle is provided with a sensor system including various types of sensors to enable a vehicle to operate in a partially or fully autonomous mode.

### 1. Initial Discussion

In this document, some embodiments for object detection using point cloud information only are described. In other words, the object information is generated without using camera images. Due to the difficulty of acquiring large-scale 3D human keypoint annotation, previous methods have commonly relied on two-dimensional (2D) image features and 2D sequential annotations for 3D human pose estimation. In contrast, some embodiments of the disclosed method uses only LiDAR as its input along with its corresponding 3D annotations. In some embodiments, the proposed method consists of two stages: the first stage detects the human bounding box and extracts multi-level feature representations, while the second stage employs a transformer-based network to regress the human keypoints using these features. Experimental results have shown that the disclosed techniques performance results better than any other known methods in the industry.

### 2. Example Vehicular Computational Platform

One example use of the proposed method is in the field of autonomous vehicle navigation. In such an implementation, the object detection performed according to disclosed technology may be used to plan future trajectory of the autonomous vehicle.

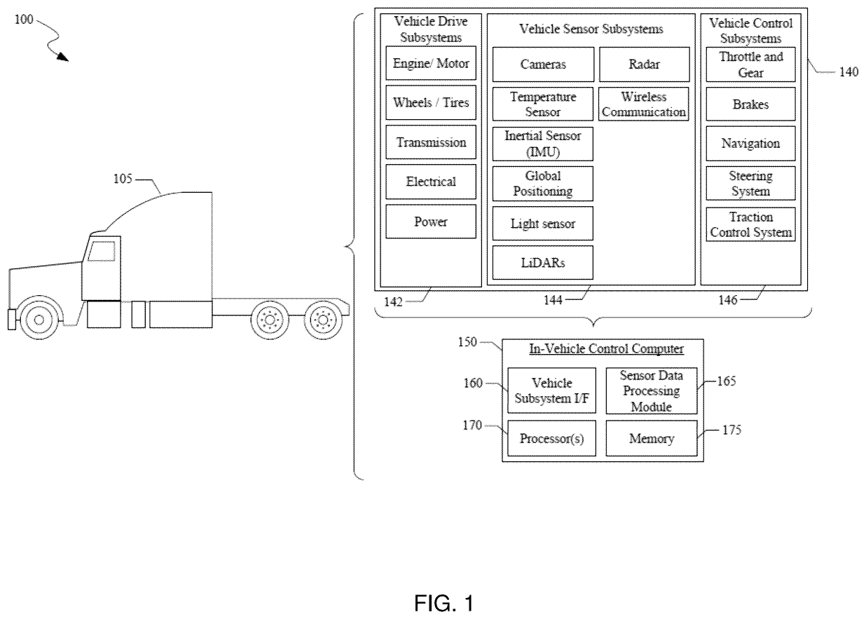

FIG. 1 shows a system 100 that is included in an autonomous (self-driving) or semi-autonomous vehicle 105. The vehicle 105 includes a plurality of vehicle subsystems 140 and an in-vehicle control computer 150. The plurality of vehicle subsystems 140 includes vehicle drive subsystems 142, vehicle sensor subsystems 144, and vehicle control subsystems. An engine or motor, wheels and tires, a transmission, an electrical subsystem, and a power subsystem may be included in the vehicle drive subsystems. The engine of the vehicle 105 may be an internal combustion engine, a fuel-cell powered electric engine, a battery powered electrical engine, a hybrid engine, or any other type of engine capable of moving the wheels on which the vehicle 105 moves. The vehicle 105 has multiple motors or actuators to drive the wheels of the vehicle, such that the vehicle drive subsystems 142 include two or more electrically driven motors. The transmission may include a continuous variable transmission or a set number of gears that translate the power created by the engine into a force that drives the wheels of the vehicle. The vehicle drive subsystems may include an electrical system that monitors and controls the distribution of electrical current to components within the system, including pumps, fans, and actuators. The power subsystem of the vehicle drive subsystem may include components that regulate the power source of the vehicle.

Vehicle sensor subsystems 144 can include sensors for general operation of the vehicle 105, including those which would indicate a malfunction in the AV or another cause for an AV to perform a limited or minimal risk condition (MRC) maneuver. The sensors for general operation of the vehicle may include cameras, a temperature sensor, an inertial sensor (IMU), a global positioning system, a light sensor, a LIDAR system, a radar system, and wireless communications supporting network available in the vehicle 105.

The in-vehicle control computer 150 can be configured to receive or transmit data from/to a wide-area network and network resources connected thereto. A web-enabled device interface (not shown) can be included in the vehicle 105 and used by the in-vehicle control computer 150 to facilitate data communication between the in-vehicle control computer 150 and the network via one or more web-enabled devices. Similarly, a user mobile device interface can be included in the vehicle 105 and used by the in-vehicle control system to facilitate data communication between the in-vehicle control computer 150 and the network via one or more user mobile devices. The in-vehicle control computer 150 can obtain real-time access to network resources via network. The network resources can be used to obtain processing modules for execution by processor 170, data content to train internal neural networks, system parameters, or other data. In some implementations, the in-vehicle control computer 150 can include a vehicle subsystem interface (not shown) that supports communications from other components of the vehicle 105, such as the vehicle drive subsystems 142, the vehicle sensor subsystems 144, and the vehicle control subsystems 146.

The vehicle control subsystem 146 may be configured to control operation of the vehicle, or truck, 105 and its components. Accordingly, the vehicle control subsystem 146 may include various elements such as an engine power output subsystem, a brake unit, a navigation unit, a steering system, and an autonomous control unit. The engine power output may control the operation of the engine, including the torque produced or horsepower provided, as well as provide control of the gear selection of the transmission. The brake unit can include any combination of mechanisms configured to decelerate the vehicle 105. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the vehicle 105. The navigation unit may additionally be configured to update the driving path dynamically while the vehicle 105 is in operation. In some embodiments, the navigation unit may be configured to incorporate data from the GPS device and one or more predetermined maps so as to determine the driving path for the vehicle 105. The steering system may represent any combination of mechanisms that may be operable to adjust the heading of vehicle 105 in an autonomous mode or in a driver-controlled mode.

The autonomous control unit may represent a control system configured to identify, evaluate, and avoid or otherwise negotiate potential obstacles in the environment of the vehicle 105. In general, the autonomous control unit may be configured to control the vehicle 105 for operation without a driver or to provide driver assistance in controlling the vehicle 105. In some embodiments, the autonomous control unit may be configured to incorporate data from the GPS device, the RADAR, the LiDAR (also referred to as LIDAR), the cameras, and/or other vehicle subsystems to determine the driving path or trajectory for the vehicle 105. The autonomous control unit may activate systems to allow the vehicle to communicate with surrounding drivers or signal surrounding vehicles or drivers for safe operation of the vehicle.

An in-vehicle control computer 150, which may be referred to as a VCU (vehicle control unit), includes a vehicle subsystem interface 160, a driving operation module 168, one or more processors 170, a compliance module 166, a memory 175, and a network communications subsystem (not shown). This in-vehicle control computer 150 controls many, if not all, of the operations of the vehicle 105 in response to information from the various vehicle subsystems 140. The one or more processors 170 execute the operations that allow the system to determine the health of the AV, such as whether the AV has a malfunction or has encountered a situation requiring service or a deviation from normal operation and giving instructions. Data from the vehicle sensor subsystems 144 is provided to in-vehicle control computer 150 so that the determination of the status of the AV can be made. The compliance module 166 determines what action needs to be taken by the vehicle 105 to operate according to the applicable (i.e., local) regulations. Data from other vehicle sensor subsystems 144 may be provided to the compliance module 166 so that the best course of action in light of the AV's status may be appropriately determined and performed. Alternatively, or additionally, the compliance module 166 may determine the course of action in conjunction with another operational or control module, such as the driving operation module 168.

The memory 175 may contain additional instructions as well, including instructions to transmit data to, receive data from, interact with, or control one or more of the vehicle drive subsystem 142, the vehicle sensor subsystem 144, and the vehicle control subsystem 146 including the autonomous Control system. The in-vehicle control computer 150 may control the function of the vehicle 105 based on inputs received from various vehicle subsystems (e.g., the vehicle drive subsystem 142, the vehicle sensor subsystem 144, and the vehicle control subsystem 146). Additionally, the in-vehicle control computer 150 may send information to the vehicle control subsystems 146 to direct the trajectory, velocity, signaling behaviors, and the like, of the vehicle 105. The autonomous control vehicle control subsystem may receive a course of action to be taken from the compliance module 166 of the in-vehicle control computer 150 and consequently relay instructions to other subsystems to execute the course of action.

The various methods described in the present document may be implemented on the vehicle 100 described with reference to FIG. 1. For example, one or more processors 170 may be configured to implement the object detection techniques described herein.

### 3. Technical Issues

Human pose estimation has gained significant popularity in the image and video domain due to its wide range of applications. However, pose estimation using 3D inputs, such as LiDAR point cloud, has received less attention due to the difficulty associated with acquiring accurate 3D annotations. As a result, previous methods on LiDAR-based human pose estimation commonly rely on weakly supervised approaches that utilize 2D annotations. These approaches often assume precise calibration between camera and LiDAR inputs. However, in real-world scenarios, small errors in annotations or calibration can propagate into significant errors in 3D space, thereby affecting the training of the network. Additionally, due to the differences in perspective, it is difficult to accurately recover important visibility information by simply lifting 2D annotations to the 3D space.

In image-based human pose estimation, the top-down method, which involves first detecting the human bounding box and then predicting the single-person pose based on the cropped features, is the most popular method. However, a significant gap exists in the backbone (computing) network between the 2D detector and the 3D detector. Most LiDAR object detectors utilize projected bird's-eye view (BEV) features to detect objects, which helps reduce computational costs. This procedure leads to the loss of separable features in the height dimension that are crucial for human pose estimation. An effective use of learned object features for human pose estimation is still unexplored.

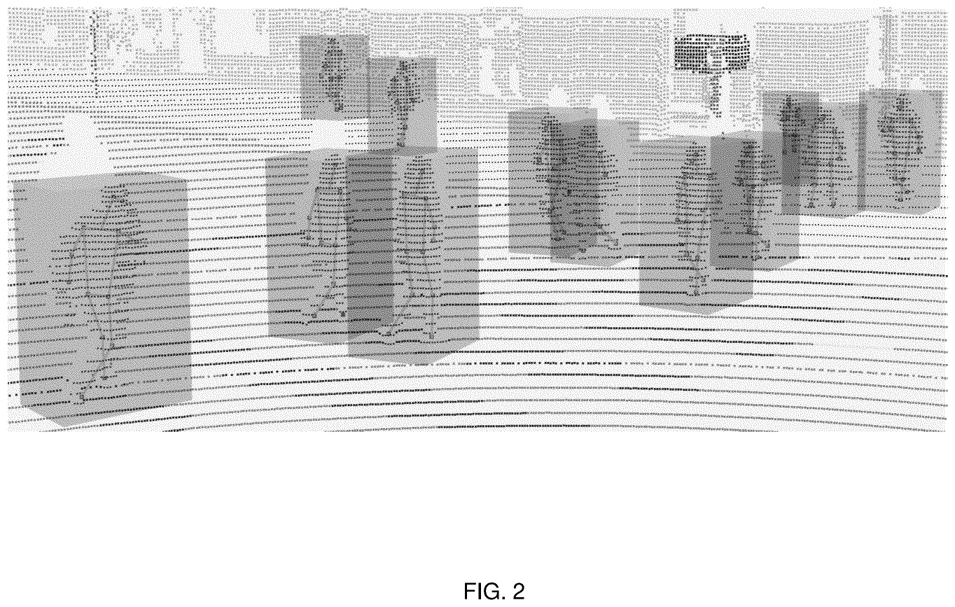

The technical solutions presented in this patent document address the above-discussed technical problems, among others. For example, implementations may use a complete two-stage top-down 3D human pose estimation framework that uses only LiDAR point cloud as input and is trained solely on 3D annotations. In the first stage, using a methodology, network that can accurately predict human object bounding boxes while generating fine-grained voxel features at a smaller scale. The second stage extracts point-level, voxel-level and object-level features of the points clouds inside each predicted bounding box and regresses the keypoints in a light-weighted transformer-based network. Our approach demonstrates that complex human pose estimation tasks can be seamlessly integrated into the LiDAR multi-task learning framework (see FIG. 2), achieving state-of-the-art performance without the need for image features or annotations. In FIG. 2, detected human objects can be seen to be enclosed in corresponding gray bounding boxes, with the bold dots representing keypoints that are connected to each other by a linear wireframe.

### 4. Image-Based 3D Human Pose Estimation

3D human pose estimation (HPE) has been extensively studied based solely on camera images, where the human pose is represented as a parameter mesh model such as skinned multipersonal linear model (SMPL) or skeleton-based keypoints. Previous works in this field can be generally categorized into two main approaches: top-down or bottom-up methods. Top-down methods decouple the pose estimation problem to individual human detection using the off-the-shelf object detection network and single-person pose estimation on the cropped object region. On the contrary, bottom-up methods first estimate the instance-agnostic keypoints and then group them together or directly regress the joint parameter using center-based feature representation. Some recent works explored using the transformer decoder to estimate human pose in an end-to-end fashion following the set matching design in DETR (DEtection TRansformer). However, image-based 3D HPE suffers from inaccuracies and is considered not applicable to larger-scale outdoor scenes due to frequent occlusion and the difficulty of depth estimation.

### 5. LiDAR-Based 3D Human Pose Estimation

To solve the depth ambiguity problem, some researchers explored using depth images for the 3D HPE. Compared to the depth image, LiDAR point cloud has a larger range and is particularly applicable to outdoor scenes, such as in autonomous driving applications. Waymo recently released the human joint keypoint annotations on both associated 2D images and 3D LiDAR point cloud on Waymo Open Dataset. However, due to the lack of enough 3D annotation, previous works have focused on semi-supervised learning approaches. These approaches lift 2D annotation to the 3D space and rely on the fusion of image and LiDAR features for the HPE task. The disclosed solutions overcome the above discussed technical issues, among other benefits.

### 6. Some Example Embodiments

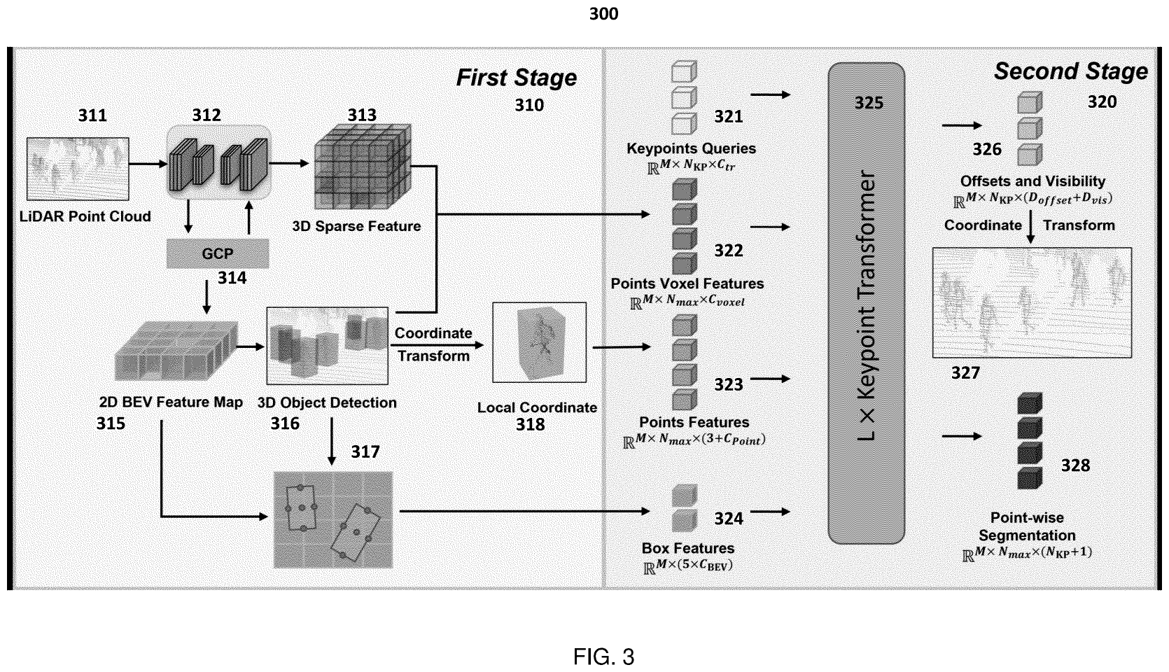

Some embodiments include a two-stage LiDAR-only model designed for 3D pose estimation. FIG. 3 provides an overview of a framework 300 that represents a workflow used for estimating poses of human objects. The two-stages include a first stage 310 and a second stage 320, as further described herein.

The input to the workflow 300 consists of only point clouds, represented as a set of LiDAR points (311) P={pᵢ|pᵢ∈ [symbol] ^{3+C}ₚₒᵢₙₜ}_{N}, where N denotes the number of points and Cₚₒᵢₙₜ includes additional features such as intensity, elongation, and timestamp for each point. In the first stage 310, the framework 300 employs a powerful multi-task network that accurately predicts 3D object detection and 3D semantic segmentation, incorporating meaningful semantic features. The second stage 320 leverages a transformer-based model. This model takes various out-puts from the first stage as inputs (321, 322, 323, 324) and generates 3D human keypoints Yₖₚ∈ [symbol] ^{N}^{ₖₚ}^{×3} along with their corresponding visibilities Yᵥᵢₛ∈ [symbol] ^{N}^{ₖₚ}, where Nₖₚ is the number of 3D keypoints.

### 7. Examples of First Stage Detection

The first stage 310 of the framework 300 may use the methodology described herein and in U.S. application Ser. No. 18/434,501, filed on Feb. 4, 2024, entitled “DETECTION OF OBJECTS IN LIDAR POINT CLOUDS,” incorporated by reference herein in its entirety, for extracting point clouds features from raw point clouds P. As depicted in FIG. 3, it consists of a 3D encoder-decoder structure 312 with Global Context Pooling (GCP) module 314 in between. The 3D object detection predictions are obtained through the 3D detection head (not explicitly shown), which is attached to the dense 2D BEV feature map.

Within each detected bounding box (e.g., 318), the points are performed by a local coordinate transformation 318 involving translation and rotation. Subsequently, the transformed points are concatenated with their corresponding original point features, resulting in Pₚₒᵢₙₜ∈ [symbol] ^{M×N}^{ₘₐₓ}^{×(3+C}^{ₚₒᵢₙₜ}⁾, where M is the number of bounding boxes and Nₘₐₓ represents the maximum number of point clouds within each bounding box (323).

For each box, the framework 300 randomly shuffles and removes extra points, and pad with zero if the number of points within a box is less than Nₘₐₓ. Additionally, the framework 300 generates point voxel features 322 Pᵥₒₓₑₗ∈ [symbol] ^{M×N}^{ₘₐₓ}^{×C}^{ᵥₒₓₑₗ} by gathering the 3D sparse features from the [symbol] decoder using their corresponding voxelization index, where Cᵥₒₓₑₗ denotes the channel size of the last stage of the decoder. For each bounding box, the framework 300 adopts the BEV (bird's eye view) features at its center as well as the centers of its edges in the 2D BEV feature map as the box features 324 B∈ [symbol] ^{M×(5×C}^{_{BEV}}⁾.

### 8. Examples of Second Stage Keypoint Transformer

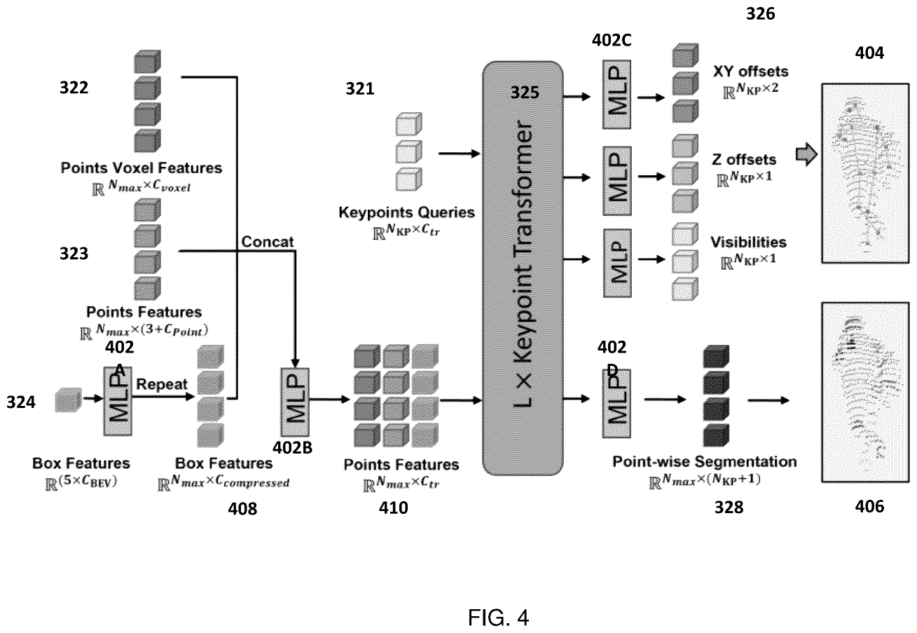

By leveraging the capabilities of the robust first stage 310, the second stage 320 is able to exploit valuable semantic features for capturing intricate object details, including human 3D pose. A transformer architecture instead of a PointNet-like structure may preferably be used as second stage, in order to effectively understand 3D keypoints by leveraging local points information through an attention mechanism. Some examples are provided in the aforementioned U.S. application Ser. No. 18/434,501, which is incorporated by reference herein. The details of example implementations of our second stage 320 are shown in FIG. 4.

Specifically, the second stage 320 takes various features from local points features 323 Pₚₒᵢₙₜ, semantic voxel-wise points features 322 Pᵥₒₓₑₗ, and box-wise features 324 B to predict 3D keypoints for each pedestrian or cyclist box. Starting with a box-wise feature B, the framework first employs a multilayer perceptron (MLP) 402A to compress its dimensions from [symbol] ^{5×C}^{_{BEV}} to [symbol] ^{C}^{_{compressed}} (408). This compressed box-wise feature 408 is then replicated as P_{box}∈ [symbol] ^{N}^{ₘₐₓ}^{×C}^{_{compressed}} and combined with point-wise features Pₚₒᵢₙₜ and Pᵥₒₓₑₗ, resulting in P_{cat}∈ [symbol] ^{N}^{ₘₐₓ}^{×(3+C}^{ₚₒᵢₙₜ}^{+C}^{ᵥₒₓₑₗ}^{+C}_{compressed}⁾. The fused point-wise features (not explicitly shown) are subjected to a simple matrix multiplication, yielding Xₚₒᵢₙₜ∈ [symbol] ^{N}^{ₘₐₓ}^{×C}^{ₜᵣ} (410), which serves as one part of the input for Keypoint Transformer (KPTR) 325. The other input for KPTR is a learnable 3D keypoints query 321 Xₖₚ∈ [symbol] ^{N}^{ₖₚ}^{×C}^{ₜᵣ}. Subsequently, the framework 300 uses KPTR 325, which consists of L blocks of a multi-head self-attention and a feed-forward network, to learn internal features X′ₚₒᵢₙₜ and X′ₖₚ. Finally, the keypoints' internal features X′ₖₚ are fed into three separate multi-layer perceptron (MLPs) 402C to predict 3D keypoints offsets along the X and Y axes Ŷ_{xy}∈ [symbol] ^{N}^{ₖₚ}^{×2} (326), 3D keypoints offsets along the Z axis Ŷ∈ [symbol] ^{N}^{ₖₚ}^{×1}, and 3D keypoints visibilities Ŷᵥᵢₛ∈ [symbol] ^{N}^{ₖₚ} (collectively, 326). Furthermore, the point-wise internal features X′ₚₒᵢₙₜ are processed by an MLP 402D to estimate pointwise keypoint segmentation Ŷ_{kpseg}∈ [symbol] ^{N}^{ₘₐₓ}^{×(N}^{ₖₚ}⁺¹⁾ (328) resulting in 406.

For the final predictions, the framework 300 combines the predicted 3D keypoints offsets Ŷ_{xy}, Ŷ_{z}, and the predicted 3D keypoints visibilities Ŷᵥᵢₛ to generate the human pose for each bounding box (404). Then the framework 300 applies a reverse coordinate transformation to convert the predicted human pose from the local coordinate system to the global LiDAR coordinate system. Moreover, the predicted pointwise keypoint segmentation Ŷ_{kpseg} serves as an auxiliary task, aiding KPTR in learning point-wise local information and enhancing the regression of 3D keypoints through the attention mechanism.

### 9. Training and Losses

During the training phase, the framework 300 may replace the predicted bounding boxes with ground truth bounding boxes that include 3D keypoints labels. This substitution is necessary since only a limited number of ground truth boxes are annotated with 3D keypoints labels. By employing this approach, we simplify and expedite the training process. Additionally, some embodiments may introduce a point-wise segmentation task for keypoints as an auxiliary task to improve the performance of 3D keypoints regression. The pseudo segmentation labels Y_{kpseg}∈ [symbol] ^{N}^{ₘₐₓ}^{×(N}^{ₖₚ}⁺¹⁾ are generated by assigning each 3D keypoint's type to its top K nearest points. This auxiliary task is supervised using cross-entropy loss, expressed as L_{kpseg}.

To facilitate the 3D keypoints regression, the framework 300 may divide it into two branches: one for the regression over the X and Y axes and another for the regression over the Z axis. This division is based on our observation that predicting the offset along the Z axis is comparatively easier than predicting it along the X and Y axes. The framework 300 may employ smooth L1 loss to supervise these regression branches, denoting them as L_{xy} and L_{z}. Note that only the visible 3D keypoints contribute to the regression losses. In addition, The framework 300 may treat the visibility of the keypoints as a binary classification problem. In some embodiments, the framework 300 may supervise it using binary cross-entropy loss as Lᵥᵢₛ.

The first stage may be pretrained following instructions in and frozen during the 3D keypoints' training phase. The framework 300 may use weight factors for each loss component, and the final loss function is formulated as follows:

$${L}_{total} = {λ}_{1} {L}_{xγ} + {λ}_{2} {L}_{z} + {λ}_{3} {L}_{vis} + {λ}_{4} {L}_{kpseg} , \qquad ( 1 )$$

where λ₁, λ₂, λ₃, λ₄ are weight factors and fixed at values of 5, 1, 1, and 1, respectively.

### 10. Results of Experiments

### 10.1 Dataset

Waymo Open Dataset released the human keypoint annotation on the v1.3.2 dataset that contains LiDAR range images and associated camera images. We use v1.4.2 for training and validation. The 14 classes of keypoints for evaluation are defined as nose, left shoulder, left elbow, left wrist, left hip, left knee, left ankle, right shoulder, right elbow, right wrist, right hip, right knee, right ankle, and head center. There are 144709 objects with 2D keypoints annotations while only 8125 objects with 3D keypoints annotations in the training dataset.

### 10.2 Metrics

We use mean per-joint position error (MPJPE) and Pose Estimation Metric (PEM) as the metrics to evaluate our method. In MPJPE, the visibility of predicted joint i of one human keypoint set j is represented by vᵢ^{j}∈[0,1], indicating whether there is a ground truth for it. As such, the MPJPE over the whole dataset is:

$$MPJPE ( Y , \hat{Y} ) = \frac{1}{{\sum }_{i , j} {v}_{i}^{j}} {\sum }_{i , j} {v}_{i}^{j} {‖ {Y}_{i}^{j} - {\hat{Y}}_{i}^{j} ‖}_{2} , \qquad ( 2 )$$

where Y and Y are the ground truth and predicted 3D coordinates of keypoints.

PEM is a new metric created specifically for the Pose Estimation challenge. Besides keypoint localization error and visibility classification accuracy, it is also sensitive to the rates of false positive and negative object detections, while remaining insensitive to the Intersection over Union (IoU) of object detections. PEM is calculated as a weighted sum of the MPJPE over visible matched keypoints and a penalty for unmatched keypoints, as shown:

$$PEM ( Y , \hat{Y} ) = \frac{{\sum }_{i ∈ M} {‖ {y}_{i} - {\hat{y}}_{i} ‖}_{2} + C \vert U \vert}{\vert M \vert + \vert U \vert} , \qquad ( 3 )$$

where M is the set of indices of matched keypoints, U is the set of indices of unmatched keypoints, and C=0.25 is a constant penalty for unmatched keypoints. The PEM ensures accurate, robust ranking of model performance in a competition setting.

TABLE 1
PEM and MPJPE results on the test split of WOD (world object detection)

| | shoulders | | elbows | | wrists | | hips | |
|---|---|---|---|---|---|---|---|---|
| Model | PEM | MPJPE | PEM | MPJPE | PEM | MPJPE | PEM | MPJPE |
| baseline | 0.2323 | 0.1894 | 0.2354 | 0.2083 | 0.2391 | 0.224 | 0.2334 | 0.1807 |
| KTD | 0.2261 | 0.1876 | 0.2301 | 0.2065 | 0.2349 | 0.2227 | 0.2276 | 0.179 |
| LPFormer | 0.1428 | 0.0462 | 0.1511 | 0.0578 | 0.1771 | 0.0951 | 0.1519 | 0.0562 |
| | knees | | ankles | | head | | all | |
| Model | PEM | MPJPE | PEM | MPJPE | PEM | MPJPE | PEM | MPJPE |
| baseline | 0.2327 | 0.1934 | 0.2345 | 0.225 | 0.2376 | 0.1984 | 0.2349 | 0.2022 |
| KTD | 0.2267 | 0.1919 | 0.229 | 0.2237 | 0.2328 | 0.1973 | 0.2295 | 0.2007 |
| LPFormer | 0.1477 | 0.0578 | 0.1479 | 0.0663 | 0.1544 | 0.0443 | 0.1524 | 0.0594 |

### 10.3. Implementation Details

During our experiments, we use a pretrained LidarMultiNet as the first stage of our framework, which remains frozen during the training phase of the second stage. For additional network and training specifics regarding our first stage, please refer to LidarMultiNet.

Regarding KPTR, the dimensions of the inputs, namely Cₚₒᵢₙₜ, Cᵥₒₓₑₗ, and C_{BEV}, are set to 3, 32, and 512, respectively. The size of the compressed features, denoted as C_{compressed}, is 32. We cap the maximum number of points per bounding box at 1024. For the transformer architecture, similar to the recent work, we utilize L=4 stages, an embedding size of Cₜᵣ=256, a feed-forward network with internal channels of 256, and 8 heads for the MultiHeadAttention layer. The total number of 3D keypoints Nₖₚ is 14.

During training, we incorporated various data augmentations, including standard random flipping, global scaling, rotation, and translation. It is important to note that flipping the point clouds has an impact on the relationships between the 3D keypoints annotations, similar to the mirror effect. When performing a flip over the X-axis or Y-axis, the left parts of the 3D keypoints should be exchanged with the right parts of the 3D keypoints accordingly.

To train our model, we use the AdamW optimizer along with the one-cycle learning rate scheduler for a total of 20 epochs. The training process utilizes a maximum learning rate of 3e-3, a weight decay of 0.01, and a momentum ranging from 0.85 to 0.95. All experiments are conducted on 8 Nvidia A100 GPUs, with a batch size set to 16.

### 10.4. Main Pose Estimation Results

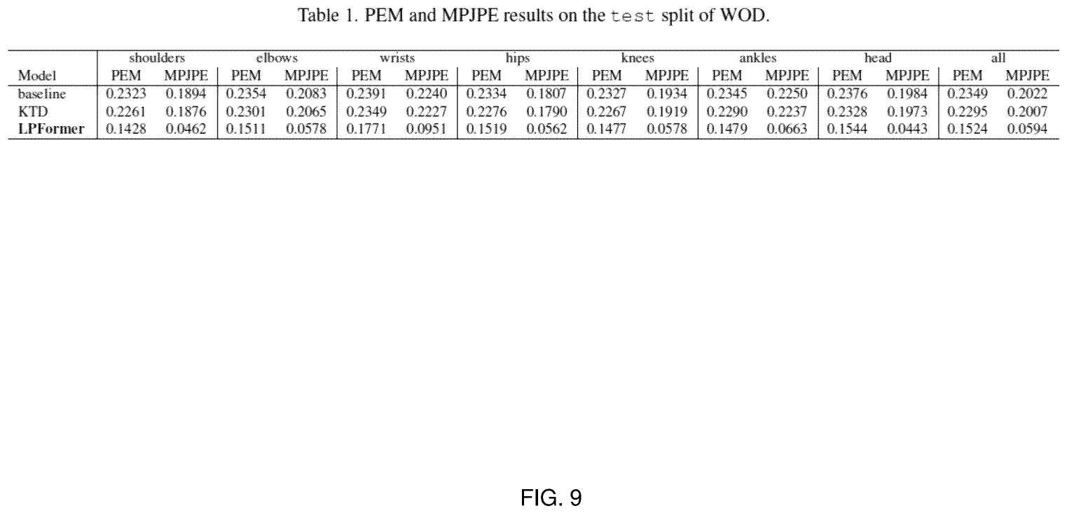

We trained our model using the combined dataset of Waymo's training and validation splits. The results, presented in Table 1 (see also FIG. 9), demonstrate the impressive performance of the framework 300 (called LPFormer in the results) achieving a PEM of 0.1524, an MPJPE of 0.0594, and ranking 1^{st} on the leaderboard. Notably, our LPFormer outperforms all other methods across all categories in terms of both PEM and MPJPE.

### 10.5. Ablation Study

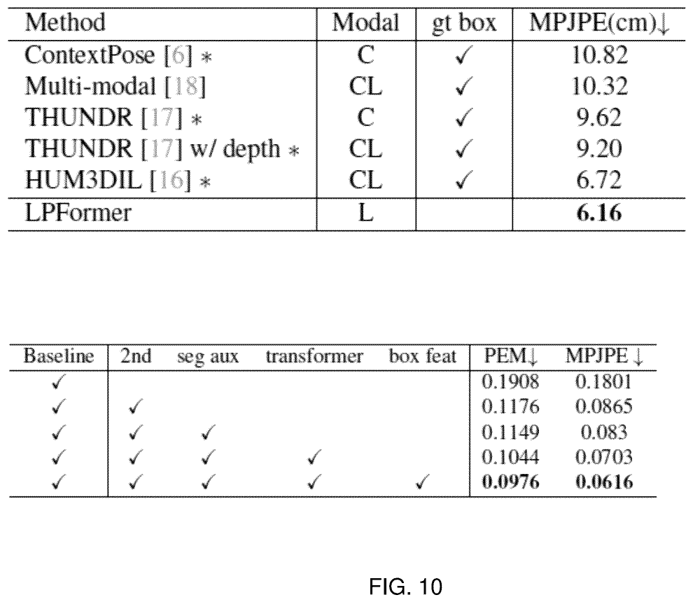

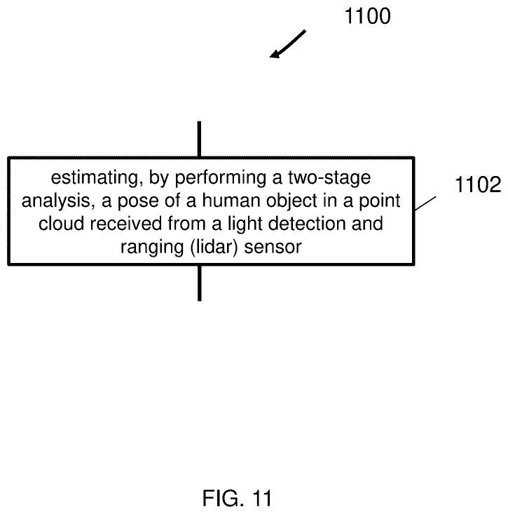

To conduct a comprehensive performance analysis of the framework 300, we compare it with other SOTA methods, as shown in Table 2 (see FIG. 10, top table). It is important to note that all previous methods were evaluated on a subset of the WOD validation split. Additionally, these methods simplify the problem by providing ground truth 3D bounding boxes along with associated ground truth 2D bounding boxes as inputs. Despite some of these methods incorporating camera and LiDAR fusion or 2D weakly supervision, our framework 300 outperforms them all in terms of MPJPE, achieving an impressive MPJPE of 6.16 cm. Table 3 (see FIG. 10, bottom table) shows a comparison of the performance between the first stage and LPFormer, as well as the contribution of each component in the second stage to the overall performance. The first stage results are directly output from the Center Head following the BEV feature map. Given the BEV feature map is primarily driven by the detection task and has low resolution, it lacks fine-grained features, resulting in mediocre performance. The second stage which is similar to Second-stage Refinement module in LidarMultiNet, however, significantly improves upon introducing point-wise fine-grained features. Further enhancements are achieved by adding the keypoint segmentation auxiliary task, employing the transformer structure, and incorporating box features, all of which contribute to varying degrees of performance improvement for the model.

TABLE 2
The comparison on the WOD value split.

| Method | Modal | gt box | MPJPE(cm)↓ |
|---|---|---|---|
| ContextPose * | C | ✓ | 10.82 |
| Multi-modal | CL | ✓ | 10.32 |
| THUNDR * | C | ✓ | 9.62 |
| THUNDR w/depth * | CL | ✓ | 9.2 |
| HUM3DIL * | CL | ✓ | 6.72 |
| LPFormer | L | | 6.16 |

* where the result is tested on randomly selected 50% of subjects from theWOD val split. “L”, “CL” denote LiDAR-only, camera & LiDAR fusion methods.

TABLE 3
The ablation of improvement of each
component on the WOD val split.

| Baseline | 2nd | seg aux | transformer | box feat | PEM↓ | MPJPE↓ |
|---|---|---|---|---|---|---|
| ✓ | | | | | 0.1908 | 0.1801 |
| ✓ | ✓ | | | | 0.1176 | 0.0865 |
| ✓ | ✓ | ✓ | | | 0.1149 | 0.083 |
| ✓ | ✓ | ✓ | ✓ | | 0.1044 | 0.0703 |
| ✓ | ✓ | ✓ | ✓ | ✓ | 0.0976 | 0.0616 |

FIG. 2 shows the output predictions of our model for one frame in the validation set, viewed from a particular angle. The input is solely 3D LiDAR point clouds. Remarkably, our network simultaneously outputs results of 3D semantic segmentation, 3D bounding boxes, as well as their 3D keypoints (filled points on the wireframes within the 3D rectangles) along with the corresponding wireframes (visible inside the shaded 3D volumes) for visualization. Our model also predicts visibility, for example, the left knee of the second person from the left is predicted as invisible, while the left foot is visible. Both feet of the third person from the right are predicted as invisible. The right elbow of the sixth person from the right is predicted as invisible, however, the right hand is visible.

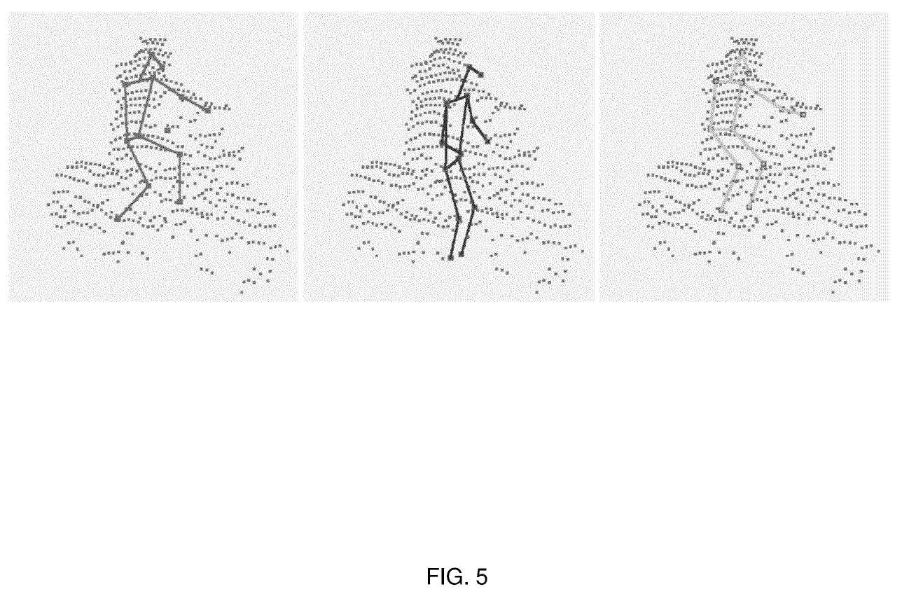

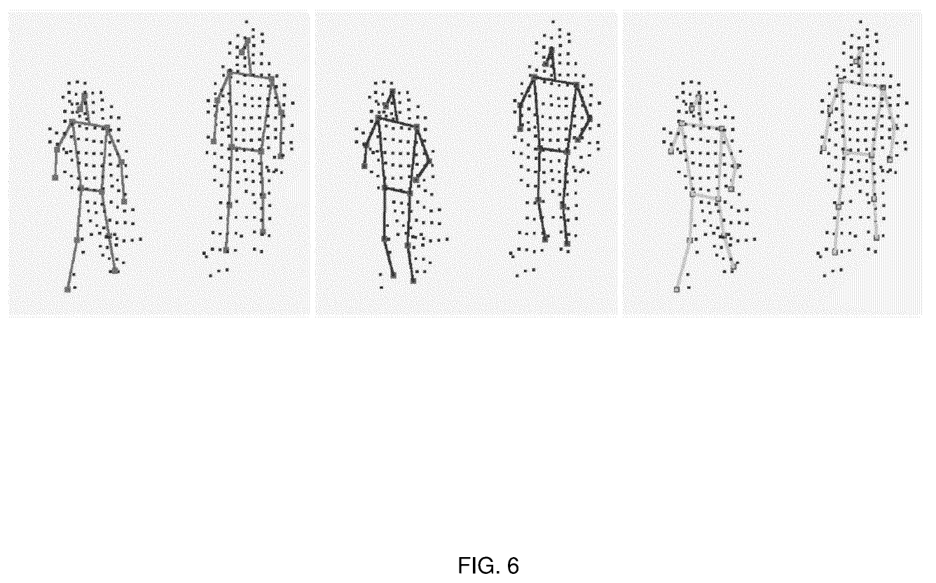

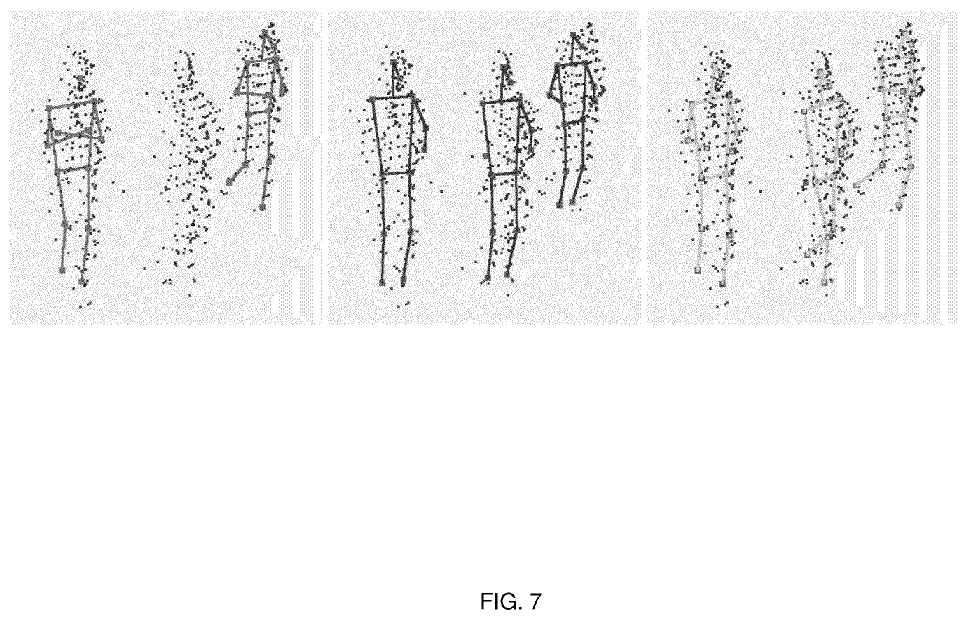

FIGS. 5-7 presents a selection of predictions made on the validation set. In FIGS. 5 to 7, from left to right, the pictures represent ground truths, the predictions of the 1^{st} stage 310, and the predictions of the two stage framework 300, respectively. Each drawings showcases the same group of objects, with FIG. 5 showing a cyclist, FIG. 6 showing two humans and FIG. 7 showing 3 humans. As can be observed, across all three groups, the performance of the framework 300 noticeably surpasses that of only the 1^{st} stage output. The first row highlights a cyclist for whom ground truth annotations are extremely limited (FIG. 5). Despite the limited number of annotations, the framework still manages to deliver meaningful output. In FIG. 6, the framework 300 is strikingly close to the ground truth, with the exception of an FN (False Negative) visibility for the right hand of the pedestrian on the left. FIG. 7 demonstrates that even on the pedestrian without ground truth annotations, the framework 300 still produces satisfactory results. For the running pedestrian on the right, the framework 300 performs pretty well. However, the left pedestrian's head center is an FP (False Positive) case, and the crossed hands pose is a difficult case given the small amount of similar ground truth annotations available.

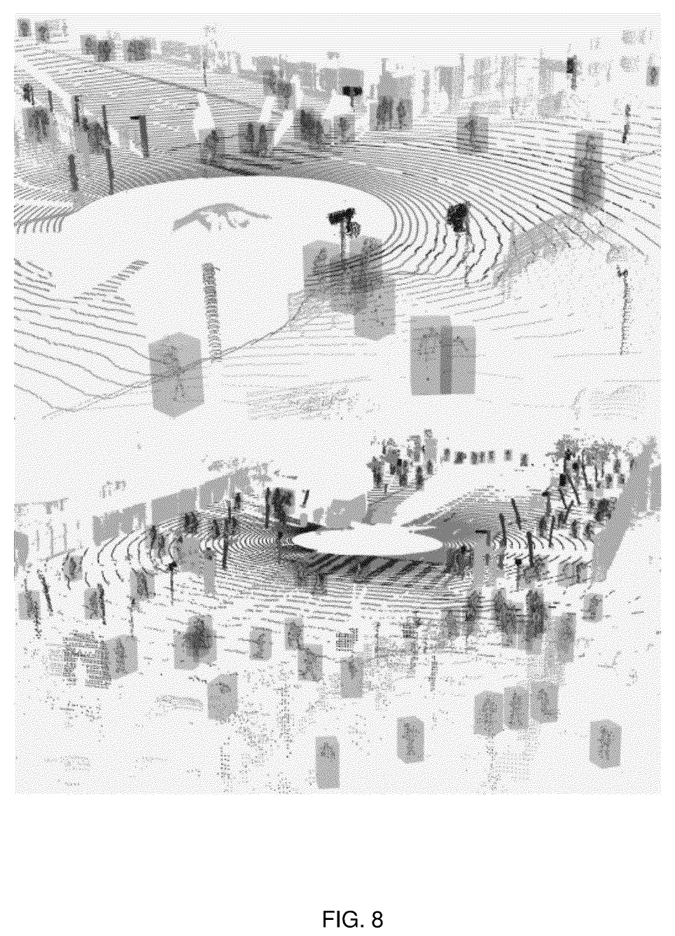

FIG. 8 demonstrates the model's performance in pedestrian-rich scenarios, as the PEM metric is sensitive to both false positive and false negative object detections. In these scenarios, the restriction on a 25 m detection range has been eliminated, while the detection score threshold and IoU threshold have been maintained. It is evident that the model can detect more distant pedestrians and provide keypoints predictions. However, it is noted that the visibility for distant pedestrians decreases, which is reasonable as the point clouds in the distance tend to be more sparse and prone to occlusion.

Some preferred embodiments according to the disclosed technology adopt the following solutions.
1. An image processing method (e.g., method 1100), comprising: estimating (1102), by performing a two stage analysis, a pose of a human object in a point cloud received from a light detection and ranging (lidar) sensor, wherein the two-stage analysis includes: a first stage (e.g., 310) in which at least three feature sets are generated from the point cloud by performing a three-dimensional (3D) object detection and a 3D semantic segmentation on the point cloud, wherein the at least three feature sets include a first set that includes local point information; and a second stage (e. g., 320) that generates one or more human pose keypoints for the human object in the point cloud by analyzing the at least three feature sets using an attention mechanism.
2. The method of solution 1, wherein the at least three feature sets include a second set that includes semantic voxel-wise point features and a third set that includes box-wise features.

Some solutions of the second stage 320 may be as follows.
3. The method of solution 2, wherein the one or more human keypoints are generated by: generating a fused feature set by combining a compressed feature set that is generated from the third set with the first set and the second set; learning internal keypoints in the point cloud by applying a keypoint transformer to the fused feature set and a learnable 3D keypoint query; determining keypoint offsets for the one or more keypoints along X, Y and Z axes based on the learning the internal keypoints; determining 3D keypoint visibilities of the one or more keypoints along the Y axis; and estimating the pose of the human object based on the keypoint offsets and the 3D keypoint visibilities.
4. The method of solution 3, wherein the compressed feature set is generated by compressing a dimension of the third set using a multilayer perceptron.

Some solutions for the first stage 310 may be as follows.
5. The method of any of above solutions, wherein the at least three features are generated by the first stage by processing the point cloud through a 3D encoder followed by a global context pooling module followed by a 3D decoder.
6. The method of any of above solutions, wherein the performing the 3D object detection and the 3D semantic segmentation comprises detecting one or more bounding boxes for human objects in the point cloud.
7. The method of any of solutions 5-6, wherein the first set is generated by performing local transformation within each detected bounding box in the point cloud and concatenating results of the performing local transformation with corresponding original features.
8. The method of solution 7, further including, removing extra points from the first set by randomly shuffling points in the first set and padding with zero in case that a number of points within a bounding box is below a threshold.
9. The method of any of solutions 5-8, wherein the second set is generated by gathering 3D sparse features from an output of the 3D decode based on corresponding voxelization indexes.
10. The method of any of solutions 5-9, wherein the third set is generated by selecting, for each bounding box, a bird's eye view (BEV) feature at a center thereof and centers of edges in a 2D BEV feature map thereof as box features.
11. An apparatus for image processing, comprising one or more processors, wherein the one or more processors are configured to perform a method comprising: estimating, by performing a two stage analysis, a pose of a human object in a point cloud received from a light detection and ranging (lidar) sensor, wherein the two-stage analysis includes: a first stage in which at least three feature sets are generated from the point cloud by performing a three-dimensional (3D) object detection and a 3D semantic segmentation on the point cloud, wherein the at least three feature sets include a first set that includes local point information; and a second stage that generates one or more human pose keypoints for the human object in the point cloud by analyzing the at least three feature sets using an attention mechanism.
12. The apparatus of solution 11, wherein the at least three feature sets include a second set that includes semantic voxel-wise point features and a third set that includes box-wise features.
13. The apparatus of solution 12, wherein the one or more human keypoints are generated by: generating a fused feature set by combining a compressed feature set that is generated from the third set with the first set and the second set; learning internal keypoints in the point cloud by applying a keypoint transformer to the fused feature set and a learnable 3D keypoint query; determining keypoint offsets for the one or more keypoints along X, Y and Z axes based on the learning the internal keypoints; determining 3D keypoint visibilities of the one or more keypoints along the Y axis; and estimating the pose of the human object based on the keypoint offsets and the 3D keypoint visibilities.
14. The apparatus of solution 13, wherein the compressed feature set is generated by compressing a dimension of the third set using a multilayer perceptron.
15. The apparatus of any of solutions 11-14, wherein the at least three features are generated by the first stage by processing the point cloud through a 3D encoder followed by a global context pooling module followed by a 3D decoder.
16. The apparatus of any of solutions 11-15, wherein the performing the 3D object detection and the 3D semantic segmentation comprises detecting one or more bounding boxes for human objects in the point cloud.
17. The apparatus of any of solutions 15-16, wherein the first set is generated by performing local transformation within each detected bounding box in the point cloud and concatenating results of the performing local transformation with corresponding original features.
18. The apparatus of solution 17, wherein the method further includes: removing extra points from the first set by randomly shuffling points in the first set and padding with zero in case that a number of points within a bounding box is below a threshold.
19. The apparatus of any of solutions 15-18, wherein the second set is generated by gathering 3D sparse features from an output of the 3D decode based on corresponding voxelization indexes.
20. The apparatus of any of solutions 15-19, wherein the third set is generated by selecting, for each bounding box, a bird's eye view (BEV) feature at a center thereof and centers of edges in a 2D BEV feature map thereof as box features.
21. An autonomous vehicle comprising the lidar sensor and the one or more processors of the apparatus recited in any of solutions 11-20.
22. A computer-storage medium having process-executable code that, upon execution, causes one or more processor to implement a method recited in any of solutions 1-10.

### CONCLUSION

It will be appreciated that techniques are described to identify human objects and pose of humans using only Lidar data (e.g., not camera images) are disclosed. The disclosed methods advantageously use a two-stage processing in which three feature sets are generated in the first stage and human pose keypoints are generated in the second stage. Put differently, no human pose keypoint calculations are made in the first stage in which the three feature sets are derived. One implementation of the disclosed method showed best-performance in a recent industry-wide competition.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. In some implementations, however, a computer may not need such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

1. An image processing method, comprising:
estimating, by performing a two-stage analysis, a pose of a human object in a point cloud received from a light detection and ranging (lidar) sensor, wherein the two-stage analysis includes:
a first stage in which at least three feature sets are generated from the point cloud by performing a three-dimensional (3D) object detection and a 3D semantic segmentation on the point cloud, wherein the at least three feature sets include a first set that includes local point information; and
a second stage that generates one or more human pose keypoints for the human object in the point cloud by analyzing the at least three feature sets using an attention mechanism.

2. The method of claim 1, wherein the at least three feature sets include a second set that includes semantic voxel-wise point features and a third set that includes box-wise features.

3. The method of claim 2, wherein the one or more human keypoints are generated by:
generating a fused feature set by combining a compressed feature set that is generated from the third set with the first set and the second set;
learning internal keypoints in the point cloud by applying a keypoint transformer to the fused feature set and a learnable 3D keypoint query;
determining keypoint offsets for the one or more keypoints along X, Y and Z axes based on the learning the internal keypoints;
determining 3D keypoint visibilities of the one or more keypoints along the Y axis; and
estimating the pose of the human object based on the keypoint offsets and the 3D keypoint visibilities.

4. The method of claim 3, wherein the compressed feature set is generated by compressing a dimension of the third set using a multilayer perceptron.

5. The method of claim 1, wherein the at least three features are generated by the first stage by processing the point cloud through a 3D encoder followed by a global context pooling module followed by a 3D decoder.

6. The method of claim 5, wherein the performing the 3D object detection and the 3D semantic segmentation comprises detecting one or more bounding boxes for human objects in the point cloud.

7. The method of claim 6, wherein a first set is generated by performing local transformation within each detected bounding box in the point cloud and concatenating results of the performing local transformation with corresponding original features.

8. The method of claim 7, further including, removing extra points from the first set by randomly shuffling points in the first set and padding with zero in case that a number of points within a bounding box is below a threshold.

9. The method of claim 5, wherein a second set is generated by gathering 3D sparse features from an output of the 3D decode based on corresponding voxelization indexes.

10. The method of claim 5, wherein a third set is generated by selecting, for each bounding box, a bird's eye view (BEV) feature at a center thereof and centers of edges in a 2D BEV feature map thereof as box features.

11. An apparatus for image processing, comprising one or more processors, wherein the one or more processors are configured to perform a method comprising:
estimating, by performing a two-stage analysis, a pose of a human object in a point cloud received from a light detection and ranging (lidar) sensor, wherein the two-stage analysis includes:
a first stage in which at least three feature sets are generated from the point cloud by performing a three-dimensional (3D) object detection and a 3D semantic segmentation on the point cloud, wherein the at least three feature sets include a first set that includes local point information; and
a second stage that generates one or more human pose keypoints for the human object in the point cloud by analyzing the at least three feature sets using an attention mechanism.

12. The apparatus of claim 11, wherein the at least three feature sets include a second set that includes semantic voxel-wise point features and a third set that includes box-wise features.

13. The apparatus of claim 12, wherein the one or more human keypoints are generated by:
generating a fused feature set by combining a compressed feature set that is generated from the third set with the first set and the second set;
learning internal keypoints in the point cloud by applying a keypoint transformer to the fused feature set and a learnable 3D keypoint query;
determining keypoint offsets for the one or more keypoints along X, Y and Z axes based on the learning the internal keypoints;
determining 3D keypoint visibilities of the one or more keypoints along the Y axis; and
estimating the pose of the human object based on the keypoint offsets and the 3D keypoint visibilities.

14. The apparatus of claim 13, wherein the compressed feature set is generated by compressing a dimension of the third set using a multilayer perceptron.

15. The apparatus of any claim 11, wherein the at least three features are generated by the first stage by processing the point cloud through a 3D encoder followed by a global context pooling module followed by a 3D decoder.

16. The apparatus of claim 11, wherein the performing the 3D object detection and the 3D semantic segmentation comprises detecting one or more bounding boxes for human objects in the point cloud.

17. The apparatus of claim 15, wherein a first set is generated by performing local transformation within each detected bounding box in the point cloud and concatenating results of the performing local transformation with corresponding original features.

18. The apparatus of claim 17, wherein the method further includes: removing extra points from the first set by randomly shuffling points in the first set and padding with zero in case that a number of points within a bounding box is below a threshold.

19. The apparatus of claim 15, wherein a second set is generated by gathering 3D sparse features from an output of the 3D decode based on corresponding voxelization indexes.

20. The apparatus of claim 15, wherein a third set is generated by selecting, for each bounding box, a bird's eye view (BEV) feature at a center thereof and centers of edges in a 2D BEV feature map thereof as box features.
